(19) United States
(12) Patent Application Publication
(10) Pub. No.: US 2016/0252124 A1
(43) Pub. Date: Sep. 1, 2016

(54) RELEASABLE FASTENER

(71) Applicant: BRIAN INVESTMENTS PTY LTD, Belmont (AU)

(72) Inventor: Brian Davies, Esperance (AU)

(21) Appl. No.: 15/048,387

(22) Filed: Feb. 19, 2016

Related U.S. Application Data
(63) Continuation-in-part of application No. PCT/AU2014/000824, filed on Aug. 19, 2014.

(30) Foreign Application Priority Data
Aug. 19, 2013 (AU) 2013903138
Feb. 25, 2015 (AU) 2015900669
Jul. 23, 2015 (AU) 2015902927

(51) Int. Cl. F16B 21/02; F16B 5/02; F16B 33/00

(52) U.S. Cl. CPC F16B 21/02; F16B 33/002; F16B 5/0258; B02C 2210/02

(57) ABSTRACT

Provided is a releasable fastener (11) for securing an object (19) to a structure (13). The structure comprises a first surface (15), and a second surface (17) against which the object is secured. A portion of the fastener is adapted to pass through a hole (25) in the object and an aperture (18) in the structure to engage a portion of the structure. The fastener comprises a head (31), a shank (33) integral with and extending from the head, and a locking element (35). The locking element is rotatably positioned on the shank, and is adapted to operatively engage relative to the aperture such that during fastening of the fastener the locking element rotates between a first position and a second position such that the object and structure are clampable between the head and the locking element.

### TECHNICAL FIELD

The present invention generally relates to a releasable fastener. In particular the invention relates to a releasable fastener to secure a first object to a second object, such as a structure, wherein only one side of one of the objects may be readily accessible.

### BACKGROUND ART

Fasteners are a common and well-used means to secure one object to another. Typically when doing so an operator is able to access both sides of each object and can therefore easily tighten the fastener to ensure the two objects are securely fastened. However, there are many instances where only one side of the object may be easily accessed. This is problematic when securing an object to another object using fasteners.

In the mining industry there are numerous applications where only one side of an object is accessible, particularly after the plant has been installed. One such application is in relation to securing wear liners to a structure. Wear liners are used extensively throughout the mining industry to protect those parts of structures which are exposed to wear. Due to their very nature, the wear liners are sacrificial and require regular replacement as they wear to a level where they no longer serve their purpose. It is therefore important that the wear liners can be readily removed. However, due to the harsh operating conditions, it is also important that the wear liners are held firmly in place during their service cycle.

Wear liners are used to protect mills, transfer chutes, crushers and other structures. Once these structures have been installed the rear side of the structure is often concealed or is difficult to access. In order to secure any object to these structures a number of solutions are available.

Fastening with conventional nuts and bolts or studded plates requires access by personnel to both sides of the structure. They therefore do not allow for quick and easy installation and removal.

Attachment methods which enable the attachment and removal of objects, particularly wear liners, from a single side of the structure are limited and have a number of disadvantages.

One of these solutions includes the use of a blind fastener or blind rivet. Normally these methods do not allow the head of the fastener to be exposed, as this would cause the failure of the retention system. They may also not be removable, rendering it difficult to replace the object secured to the structure.

A further deficiency in using some forms of blind fasteners is that they rely upon a complementary match of the surface profile of the structure with the engaging surface profile of the wear liner as they have a fixed ‘grip length’ i.e. it is important that the underside surface of the wear liner closely mirrors that of the surface it is to protect. Where this does not occur the operator may be prevented from being able to install the fasteners to secure the object properly or at all.

Some blind fasteners also require complex parts in their design or specialised installation and removal tooling

Other methods for securing and removing wear liners to structures involve welding of the liner to the structure and thermal cutting them away from the structure when ready to be replaced. This involves dangerous and time intensive ‘hot work’ every time the liner is changed. It can also be damaging to the structure and the new wear liner. In addition to this, the requirement for welding limits the range of suitable material which can be selected for use as a wear liner.

Several methods which allow for single-sided attachment and removal of a wear liner require the permanent fixing of an adapter or retainer to the structure. The deficiency in many of these systems is that the adapters or retainers are vulnerable to damage, as they sit upon the surface of the structure which is exposed to wear. If these adapters or retainers are damaged, hot work including thermal cutting and welding is needed to replace it with a new one before another liner can be fitted.

The preceding discussion of the background art is intended to facilitate an understanding of the present invention only. The discussion is not an acknowledgement or admission that any of the material referred to is or was part of the common general knowledge as at the priority date of the application.

### SUMMARY OF INVENTION

It is an object of this invention to provide to a releasable fastener which ameliorates, mitigates or overcomes, at least one disadvantage of the prior art, or which will at least provide the public with a practical choice.

The present invention provides a releasable fastener for securing an object to a structure, the structure comprising a first surface, and a second surface against which the object is secured, a portion of the fastener being adapted to pass through the object (typically through a hole) and engage a portion of the structure, the fastener comprising a head, a shank integral with and extending from the head, and a locking element rotatably positioned on the shank, the locking element being adapted to operatively engage with a first portion of the structure such that upon fastening of the fastener, the object and structure are clamped between the head and the locking element.

The present invention further provides a releasable fastener for securing an object to a structure, the structure comprising a first surface, and a second surface against which the object is secured, a portion of the fastener being adapted to pass through the object and engage a portion of the structure, the fastener comprising a head, a shank integral with and extending from the head, and a locking element rotatably positioned on the shank, the locking element being adapted to operatively engage relative to a slotted aperture such that during fastening of the fastener, the locking element rotates between a first position and a second position such that the object and structure are clampable between the head and the locking element.

The present invention further provides a releasable fastener for securing an object to a structure, the structure comprising a first surface, and a second surface against which the object is secured, a portion of the fastener is adapted to pass through the object and an aperture in the structure to engage a portion of the structure, the fastener comprising:
a head,
a shank integral with and extending from the head,
a nut comprising a locking element rotatably positioned on the shank, the locking element being adapted to operatively engage the aperture such that during fastening of the fastener, the locking element rotates between a first position and a second position such that the object and structure are clampable between the head and the locking element.

The present invention further provides a releasable fastener for securing an object to a structure, the structure comprising a first surface, and a second surface against which the object is secured, a portion of the fastener being adapted to pass through the object and an aperture in the structure to engage a portion of the structure, the fastener comprising:
a head,
a shank integral with and extending from the head,
a locking element rotatably positioned on the shank, the locking element being adapted to operatively engage relative to the aperture such that during fastening of the fastener, the locking element rotates between a first position and a second position such that the object and structure are clampable between the head and the locking element when the locking element is in the second position;
a prevention means to retain a restraining portion of the locking element within the aperture in the structure when fastening or unfastening the fastener.

The locking element may be incorporated in a nut. The nut may also incorporate the restraining portion.

Preferably the prevention means ensures that, during installation of the releasable fastener, the restraining portion of the locking element remains within the aperture of the structure, wherein the restraining portion of the locking element is configured to prevent rotation of the locking element beyond the second position, when fastening the fastener.

Preferably the prevention means ensures that during unfastening of the releasable fastener, the restraining portion remains within the aperture of the structure, wherein the restraining portion is configured to prevent rotation of the locking element beyond the first position.

As the restraining portion remains within the aperture the head and shank may be rotated to cause the nut to move up and down the shank. If the restraining portion moved out of the aperture, the nut would be free to rotate with the rotation of the head and shank, and the operator would not be able to fasten the fastener.

In addition the prevention means ensures that the nut cannot pass through the aperture of the structure when installing or removing the object from the structure. For example, this will prevent the nut from falling from the rear side of a vertical structure during installation or removal of the object.

In one aspect of the invention the prevention means is in the form of a restriction element which provides an obstruction to prevent the nut from passing entirely through the aperture, ensuring the restraining portion remains within the aperture of the structure.

In one variation of this aspect the restriction element is in the form of an enlarged portion wherein the smallest radial dimension of the enlarged portion is greater than the smallest radial dimension of the aperture of the structure.

The restriction element may be in the form of a flange incorporated with the nut and located at a distal end from the locking element. The distance between the flange and the locking element is such that the restraining portion of the locking element may remain within the aperture of the structure when the fastener assembly is received therein.

In various embodiments the thickness of the restriction element/flange is accommodated by a recess in an underside of the head of the fastener, a recess in a first surface of the object, a recess in the structure, or a recess in an intermediate layer located between the structure and the object. In operation this prevents the abutment of the nut and head which would prevent sufficient fastening of the fastener.

In another embodiment the thickness of the head is less than the depth of the hole in the object such that an underside of the head is inwardly spaced from the first surface of the object. Once fastened on the structure a cavity/gap is formed in the hole of the object between the underside of the head and the second surface of the structure. This cavity/gap accommodates the restriction element/flange.

The nut may provide the restriction element so that the restriction element is integral with the nut wherein the distance between the restriction element and the locking element is fixed.

Alternatively the restriction element may co-operate with the nut such that the distance between the restriction element and the locking element is adjustable. The restriction element may be in the form of a sleeve which threadingly receives the nut. The sleeve may be threadingly receivable on the shank.

In another variation of this aspect the restriction element is in the form of a projection spaced rearwardly from the rear side of the structure. An elongate element may secure the projection to the rear side of the structure at a position adjacent the aperture in the structure. Alternatively an elongate element may secure the projection to an adapter which is received in the aperture of the structure. The adapter may provide the aperture to which the locking element operatively engages to fasten the object to the structure.

In another aspect of the invention the prevention means is in the form of a limiting means located at or adjacent the end of the shank and remote from the head for preventing the nut from detaching from the shank. The limiting means may be in the form of a collar secured to or adjacent the end portion of the shank. The collar may be in the form of a sleeve which is crimped to or adjacent the end portion of the shank. The collar may be in many forms such as a plastic cap, a projection extending from the shank, a lockable nut. The limiting means may be sufficiently spaced from the locking element such that during at least installation of the releasable fastener the restraining portion of the nut remains within the aperture of the structure. Preferably the limiting means may be spaced from the nut such that the distance between the nut and the limiting means is substantially equal to the distance the nut would travel relative to the head in a quarter turn of the shank.

The collar and nut may combine to provide a limiting assembly wherein the collar and nut are in a predetermined spaced apart arrangement. Preferably when the limiting assembly is threadingly received on the shank and wound thereon, the distance between the collar and nut remain the same. Preferably when the limiting assembly is wound off the shank the collar remains fixed while the nut moves toward the collar until it is in abutment therewith, preventing the nut from further rotation relative to the shank. Preferably the space between the collar and nut is such that during at least installation of the fastener relative to the aperture, the restraining portion remains within the aperture.

The aperture may be slotted or may co-operate with an adapter which has a slotted aperture therein.

The present invention further provides a releasable fastener for securing an object to a structure, the structure comprising a first surface, and a second surface against which the object is secured, a portion of the fastener being adapted to pass through the object and an aperture in the structure to engage a portion of the structure, the fastener comprising:
a head,
a shank integral with and extending from the head,
a locking element rotatably positioned on the shank, the locking element being adapted to operatively engage relative to the aperture such that during fastening of the fastener, the locking element rotates between a first position and a second position such that the object and structure are clampable between the head and the locking element;
a limiting means located at or adjacent an end portion of the shank remote from the head, the limiting means being sufficiently spaced from the locking element such that during at least removal of the releasable fastener a restraining portion of the locking element remains within the aperture.

Preferably the locking element is limited in its movement along the shank so that the restraining portion remains within the aperture.

The aperture may be slotted or may co-operate with an adapter which has a slotted aperture therein.

The present invention further provides a releasable fastener for securing an object to a structure, the structure comprising a first surface, and a second surface against which the object is secured, a portion of the fastener being adapted to pass through the object and an aperture in the structure to engage a portion of the structure, the fastener comprising:
a head,
a shank integral with and extending from the head,
a locking element rotatably positioned on the shank, the locking element being adapted to operatively engage relative to the aperture such that during fastening of the fastener, the locking element rotates between a first position and a second position such that the object and structure are clampable between the head and the locking element;
a limiting means located at or adjacent an end portion of the shank remote from the head, the limiting means being sufficiently spaced from the locking element such that during at least installation of the releasable fastener a restraining portion of the locking element remains within the aperture.

The aperture may be slotted or may co-operate with an adapter which has a slotted aperture therein.

The present invention further provides a releasable fastener for securing an object to a structure, the structure comprising a first surface, and a second surface against which the object is secured, a portion of the fastener being adapted to pass through the object and engage a portion of the structure, the fastener comprising a head, a shank extending therefrom and a locking element supported on the shank, the locking element being adapted to operatively engage with a first portion of the structure such that upon fastening of the fastener, the object and structure are clamped between the head and the locking element.

In contrast to the prior art, the present invention allows the object to be easily installed, removed and replaced, along with the releasable fastener. Furthermore, the configuration of the head of the fastener is such that should it experience significant wear it will still continue to secure the object relative to the structure, but when replacement of the object is required, the fastener can be readily deactivated and the object removed.

The fastener is designed to be used with structures where the first surface of the structure is not readily accessible once the structure is complete. However, it is to be understood that this invention is not limited to such an application. It is readily understood that the present invention can be applied to all manner of structures, providing a convenient and quick means to secure and subsequently remove the object from the structure.

The first portion of the structure may provide an aperture for receiving the locking element of the fastener. The aperture may be in the form of a slot. The structure may have a plurality of slotted apertures, each adapted to enable operative engagement with a fastener.

Preferably the locking element is receivable in the aperture when the locking element is in a first position, and is releasably locked with respect to the structure when the locking element is in a second position.

In one aspect of the invention the slotted aperture is formed in the structure post installation of the structure.

In another aspect of the invention the slotted aperture is formed in the structure during construction of the structure.

Preferably the head is received in a hole in the object such that an outer surface of the head is flush with the outer surface of the object when the fastener is installed.

A sidewall of the head may provide a tapered portion. The tapered portion may extend along the length of the sidewall of the head to define a generally frusto-conical head. The head may have a first tapered sidewall and a second tapered sidewall, defining a step in the sidewall of the head at the junction of the first tapered sidewall and the second tapered sidewall. The second tapered sidewall may be adjacent a bottom wall of the head and be of a larger diameter than the first tapered sidewall at the junction. In those embodiments in which the sidewall of the opening is also tapered, the configuration of the head ensures the bottom section of the sidewall of the head remains in contact with the sidewall of the hole as the head wears. It also accommodates variations in the opening which may otherwise lead to unsatisfactory positioning of the fastener within the hole when installed and fastened. If upon installation the head of the fastener is only in contact with the upper portion of the sidewall of the opening, then as the head and object wears beyond the areas of initial contact, the fastener and object may become loose and the attachment of the object to the structure will be compromised. The configuration of the head enables the clamping forces to be distributed through the sidewall of the hole of the object through the service life of the object, leading to a more robust means of securing the object to the structure.

The shank may have a diameter smaller than the width of the bottom wall of the head. The shank may have a diameter smaller than the diameter of the bottom wall of the head.

In one aspect of the invention the hole in the object is shaped to complement the head, wherein a sidewall of the hole is the same or similarly tapered as the tapered portion of the head.

In another aspect of the invention the angle of the sidewall of the hole is slightly offset to the angle of the tapered portion of the head.

The locking element may be located at an end of the shank remote from the head.

In one aspect of the invention the locking element is formed integral with the shank to provide a unitary member.

Preferably the shank is threadingly received in the head. In this arrangement rotation of the head may wind the head on or off the shank.

Preferably there is resistive engagement between the head and the shank, whereby the resistive engagement causes the shank to rotate with the head when the head is rotated, the resistive engagement being overcome when the locking element secured to the shank has passed to the second position and sufficient force is applied thereto to overcome the resistive engagement. Further rotation of the head then fastens the fastener.

The resistive engagement may be provided by a coating on the external threads of the shank and/or a coating on the internal threads of the head. The coating may be in the form of thread tape, a non-setting silicone, wax or binder. The coating may also inhibit rust and debris (especially mining fines) from forming on the threaded portions. The coating may also reduce any play/slack between the head and the shank.

In another aspect of the invention the locking element is threadingly received on the shank. Preferably the shank is formed integral with the head to provide a unitary member. In this arrangement rotation of the head may wind the head and shank on or off the locking element.

Preferably there is resistive engagement between the shank and the locking element, whereby the resistive engagement causes the locking element to rotate with the shank when the shank/head are rotated, the resistive engagement being overcome when the locking element has passed to a second position and sufficient force is applied thereto to overcome the resistive engagement. Further rotation of the head then fastens the fastener.

It is to be noted that the use of this resistive engagement between the shank and the locking element is counter-intuitive to the normal practice of having a nut rotate relatively freely upon a bolt during the fastening stage. It is also to be noted that the resistive engagement does prevent unlocking of the fastener as would say a conventional “Nyloc” element on a nut as the releasable faster could release without any relative rotation between the nut and the shank: e.g. the whole fastener could rotate as a unit and cause the clamping member/locking element to move to the first position (i.e. unlocked), thus releasing the fastener.

The resistive engagement may be provided by a coating on the external threads of the shank and/or a coating on the internal threads of the locking element. The coating may be in the form of thread tape, a non-setting silicone, wax or binder. The coating may also inhibit rust and debris (especially mining fines) from forming on the threaded portions. The coating may also reduce any play/slack between the locking element and the shank.

The resistive engagement may be provided by a sleeve fitted over the external threads of the shank.

The resistive engagement may be provided by a nylon ring incorporated in the locking element, or the locking element may be in the form of conelock crimping.

Alternatively the resistive engagement may be provided by a deformity incorporated in the threaded section of the locking element. For instance the threaded section may be slightly deformed in its cross sectional shape, a portion of its threaded section may not be uniform, or the thread of the threaded section may not be complementary to the thread of the shank.

In those embodiments where the locking element is threadingly received upon the shank, the releasable fastener may comprise a prevention means in the form of a limiting means located at an end portion of the shank remote from the bolt head. The limiting means may be sufficiently spaced from the locking element such that during at least installation of the releasable fastener a restraining portion of the locking element remains within the aperture.

Preferably the limiting means may be spaced from the locking element such that the distance between the locking element and the limiting means is substantially equal to the distance the locking element would travel relative to the bolt head in a quarter turn of the shank.

Preferably the limiting means also prevents the locking element from detaching from the shank.

The limiting means may be in the form of a collar.

In one aspect of the invention the collar is secured to or adjacent the end portion of the shank. The collar may be in the form of a sleeve which is crimped to or adjacent the end portion of the shank. The collar may be in many forms such as a plastic cap, a projection extending from the shank, a lockable nut.

In another aspect of the invention the collar and locking element combine to provide a limiting assembly wherein the collar and locking element are in spaced apart arrangement. Preferably when the limiting assembly is threadingly received on the shank and wound thereon, the distance between the collar and locking element remains the same. Preferably when the limiting assembly is wound off the shank the collar remains fixed while the locking element moves toward the collar until it is in abutment therewith, preventing the locking element from further rotation relative to the shank.

Preferably the space between the collar and locking element is such that during at least installation of the releasable fastener relative to the aperture the locking element has a portion which remains within the aperture.

Preferably the locking element comprises a clamping portion wherein the clamping portion assists in clamping the object to the structure.

Preferably the locking element comprises a locking member to lock the clamping portion in a manner which prevents rotation of the clamping portion beyond the second position.

The restraining portion may be provided by all or part of the locking member.

Preferably the locking element further comprises a mating surface which aligns with and mates with a complementary mating surface of the aperture to releasably retain the locking element with respect to the aperture when the locking element is in the second position.

Preferably the angular displacement of the locking element between the first position and second position is less than 180°.

Preferably the angular displacement of the locking element between the first position and second position is 90°.

Preferably the fastener comprises an identification means to identify whether the locking element is in the first position or second position. The identification means may be in the form of indicia on an end of the shank adjacent the head. This is particularly beneficial when the locking element and shank are integrally formed.

Preferably the fastener comprises a retaining means to retain the locking element in the second position.

Preferably the retaining means assists to prevent, or at least minimise accidental rotation of the locking element from the second position to the first position. The retaining means may be in the form of a detent arrangement.

The detent arrangement may be in the form of a resilient projection extending from a surface of the locking member, whereby the projection engages the side of the aperture as the locking element passes between the first position to the second position. The projection may provide resistance to the rotation of the locking element, whereby when a prescribed force is applied the initial resistance is overcome, causing the resilient projection to deform or retract to allow the further rotation of the locking element to the second position.

The resilient projection may be vulcanised or glued to the surface of the locking member. The resilient projection may be silicon.

Preferably the initial resistance provided by the projection is less than the resistive engagement between the head and the unitary shank and locking element. This allows an operator to rotate the head, resulting in simultaneous rotation of the unitary shank and locking element, and causing the locking element to move from the first position to the second position.

Preferably the initial resistance provided by the projection is less than the resistive engagement between the shank and the locking element. This allows an operator to rotate the unitary head and shank, resulting in simultaneous rotation of the locking element, causing the locking element to move from the first position to the second position.

The resilient projection may be on at least one of the curved surfaces.

Preferably the resilient projection may be disposed towards the clamping portion of the locking member.

The locking member may be adjacent the clamping portion.

Preferably the resilient projection may be located adjacent the clamping portion.

A restraining portion of the locking member may be confined to the slotted aperture when the locking element is received in the aperture and the object and structure are not securely clamped between the head and the locking element. Before the fastener has been fastened and the object secured to the structure, the locking member is partially located within the aperture. In this position the object may still be retained relative to the structure but the object is capable of a degree of movement relative to the structure. The fastener will need to be fastened in order to secure the object to the structure. The limiting means may be positioned to ensure the restraining portion of the locking element is confined to the slotted aperture when the locking element is received in the aperture, before the fastener is fastened

The locking member may be completely confined to the slotted aperture when the locking element is received in the aperture and the object and structure are securely clamped between the head and the locking element. When the fastener has been fastened and the object is secured to the structure such that object is held in position, the locking member is located in the confines of the aperture and the clamping portion bears against the surface of the structure adjacent the aperture.

The cross sectional profile of the locking member may have a first dimension which is less than the smallest dimension of the aperture, and a second dimension greater than the smallest dimension of the aperture such that as the locking member is rotated the locking element may be rotated between the first position and the second position. With this arrangement the locking element may only be rotated from the first position to the second position, and rotated in the reverse direction from the second position to the first position. The configuration of the locking member prevents rotation of the locking element past the second position.

The cross sectional profile of the locking member is of a rectangular or square configuration modified such that two diagonally opposed corners are curved such that as the locking member is rotated the curved corners permit the locking element to be rotated between the first position and the second position. Preferably the distance between the two curved corners is equal to or less than the smallest dimension of the aperture. Preferably the distance between the two non-curved corners is greater than the smallest dimension of the aperture.

Preferably the clamping portion comprises two arms extending outwardly relative to the locking member in an opposed relation. The extent of the arms is less than the largest dimension of the aperture such that the clamping portion may be received therethrough.

The hole in the object may have a diameter which is greater than the extent of the two arms. The smallest diameter of the tapered sidewall of the hole is greater than the extent of the two arms.

The smallest diameter of the tapered sidewall of the hole may be smaller than the smallest diameter of the head. With this configuration the bottom wall of the head is spaced from the structure when the fastener is installed and fastened. In another embodiment the smallest diameter of the tapered sidewall of the hole is sized such that when the head is received therein and the fastener is installed and fastened, the bottom wall of the head is in direct engagement with the structure while the sidewall of the head is still able to engage with the sidewall of the hole.

When the locking element is in the first position the clamping portion is arranged such that it aligns with the slotted aperture, allowing the arms to pass therethrough. When the locking element is in the second position, the clamping portion bears against the first surface of the structure as the fastener is tightened. In the ideal situation, the fastener is only removed from the structure after the fastener is loosened and the locking element rotated back to the first position.

Preferably the head is adapted to co-operate with a tool to fasten the fastener relative to the structure. Preferably the head is able to co-operate with the tool after the head has been worn extensively.

Preferably the head has at least two openings in spaced relation, each opening is adapted to receive a corresponding projection of the tool, whereupon rotation of the tool the projections received in the openings cause the fastener to rotate such that the locking element moves from the first position to second position when installing the fastener, and vice versa when removing the fastener. When installing the fastener, further rotation of the head will result in the object being clampingly secured between the surface and the head while the locking element remains in the second position. The openings may extend from the upper surface of the head and terminate adjacent the bottom wall of the head. The openings may be parallel relative to each other. This ensures the tool can be used to rotate the head regardless of its wear profile.

The head may be adapted to be rotated by a tool. The head may have a hexagonal outer shape for receiving a tool on its external surface. The head may have a blind bore therein wherein the bore is hexagonal, the bore may receive a tool therein

Once the fastener is installed the openings in the head may be filled with a removable material. Each opening may have a plug inserted in the bottom of the opening before a material is placed therein to seal the opening. The filling of the opening ensures that each opening is not compromised during the objects service life, allowing the tool to readily engage the openings, rotate the head, and remove the fastener when required.

The sidewalls and/or bottom wall of the head may be coated in a material to prevent corrosion and/or reduce friction between the head, opening and/or structure. The material may be a graphite compound, silicone or other type of coating.

The head may be releasably retained relative to the tool to assist in installation and removal of the fastener. The tool may have a plurality of magnets to releasably retain the head thereon.

The fastener may comprise a resilient grommet. The grommet may be locatable in the aperture of the structure during installation of the fastener. Upon the locking element moving from the first position to the second position the grommet may be compressed into and fill the aperture. The grommet may be compressed into the aperture as the fastener is fastened. The grommet may be made from a compressible polymer. The grommet effectively seals the aperture preventing, or at least minimising, the ingress of sulfides, salts, fines and other material into the aperture. This therefore inhibits corrosion within the aperture and prevents fluid from passing through the aperture. Furthermore, the grommet prevents accidental ‘back turning’ of the locking element, assisting in retaining it in position.

Preferably the fastener comprises at least one sensor for measuring one or more of a variety of characteristics of the releasable fastener and/or the environment within which it operates.

In one aspect of the invention the at least one sensor measures the wear experienced by the head and transmits this data so that an operator is able to predict when the wear liner may need to be replaced. The sensor may transmit data via a wired infrastructure or through a wireless system.

In another aspect of the invention the sensor is in the form of an accelerometer for measuring vibrations through the releasable fastener. As would be known by the person skilled in the art the sensor may take many different forms dependent upon the data the operator wishes to collect.

Preferably the sensor extends through the shank and terminates in close proximity to the outer surface of the head.

Preferably the sensor is received in a cavity in the shank of the fastener.

Preferably the sensor has a transmitter secured to or relative to the end of the shank for transmitting data collected by the sensor. The transmitter may be secured to the locking element.

The present invention provides a structure adapted to have a plurality of wear liners secured thereto using a plurality of fasteners as herein before described, the structure having an array of slotted apertures formed therein, the array of apertures adapted to align with holes in the plurality of wear liners.

The present invention further provides a releasable fastener for securing an object to a structure, the structure comprising a first surface, a second surface against which the object is secured and a slotted aperture, the fastener being adapted to operatively engage the slotted aperture and a hole in the object to releasably secure the object to the structure, the fastener comprising a head, a shank extending therefrom and a locking element supported on the shank, the locking element being adapted to operatively engage relative to the slotted aperture such that upon fastening of the fastener, the locking element rotates between a first position and a second position such that the object and structure are clamped between the head and the locking element.

Preferably the fastener is unlocked by rotating the locking member in the reverse direction from the second position to the first position.

The present invention further provides a releasable fastener for securing an object to a structure, the structure comprising a first surface, a second surface against which the object is secured and a slotted aperture, the fastener being adapted to be received relative to a hole in the object to releasably secure the object to the structure, the fastener comprising a head, a shank extending therefrom and a locking element supported on the shank, the locking element being adapted to operatively engage relative to the slotted aperture such that upon fastening of the fastener, the locking element rotates between a first position and a second position such that the object and structure are clamped between the head and the locking element.

The present invention further provides a releasable fastener for securing an object to a structure, the structure comprising a first surface, and a second surface against which the object is secured, a portion of the fastener being adapted to pass through the object and a slotted aperture in the structure to engage a portion of the structure, the fastener comprising:
a head,
a shank integral with and extending from the head,
a nut comprising a locking element rotatably positioned on the shank, the locking element being adapted to operatively engage the slotted aperture such that during fastening of the fastener, the locking element rotates between a first position and a second position such that the object and structure are clampable between the head and the locking element.

During fastening of the fastener, the locking element rotates between the first position and the second position. When in the second position the object and structure are clampable between the head and the locking element. To clamp the object and structure together the fastener needs to be fastened. This is achieved by continuing to rotate the head after the locking element has passed to the second position, until the required clamping force is reached.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is side view of a shank and a locking element of a fastener according to a first embodiment of the invention;

FIG. 2 is a right hand end view of FIG. 1;

FIG. 3 is side view of a shank and a locking element of a fastener according to a second embodiment of the invention;

FIG. 4 is a left hand end view of FIGS. 1 and 3;

FIG. 5 is a right hand end view of FIG. 3;

FIG. 6 is a cross sectional side view of a head which may be used with either fastener of the first or second embodiments;

FIG. 7 is an end view of FIG. 6;

FIG. 8 a, b, c is a cross sectional side view of the fastener of the first embodiment in a second position securing an object to a structure;

FIG. 9 a, b, c is a cross sectional side view of the fastener of the second embodiment in a second position securing an object to a structure;

FIG. 10 is perspective view of an assembled releasable fastener according to a third embodiment of the invention;

FIG. 11 is a side view of FIG. 10;

FIG. 12 is an exploded view of FIG. 10;

FIG. 13 is perspective view of an assembled releasable fastener according to a fourth embodiment of the invention;

FIGS. 14 and 15 are exploded perspective views of a fastener assembly according to a fifth embodiment of the present invention, shown at different angles;

FIG. 16 is a rear perspective view of a wear liner assembly having a wear liner and four fastener assemblies as shown in FIGS. 14 and 15;

FIG. 17 is a front view of the wear liner assembly shown in FIG. 16;

FIG. 18 is a view of section AA identified in FIG. 17;

FIGS. 19 and 20 are exploded perspective views of a fastener assembly according to a sixth embodiment of the present invention, shown at different angles;

FIG. 21 is a rear perspective view of a wear liner assembly having a wear liner and four fastener assemblies as shown in FIGS. 19 and 20;

FIG. 22 is a front view of the wear liner assembly shown in FIG. 21;

FIG. 23 is a view of section AA identified in FIG. 22;

FIGS. 24 and 25 are exploded perspective views of a fastener assembly according to a seventh embodiment of the present invention, shown at different angles;

FIG. 26 is a rear perspective view of a wear liner assembly having a wear liner and four fastener assemblies as shown in FIGS. 24 and 25;

FIG. 27 is a front view of the wear liner assembly shown in FIG. 26; and

FIG. 28 is a view of section AA identified in FIG. 27.

In the drawings like structures are referred to by like numerals throughout the several views. The drawings shown are not necessarily to scale, with emphasis instead generally being placed upon illustrating the principles of the present invention.

### DESCRIPTION OF EMBODIMENTS

The present invention provides a fastener 11 for securing a first object to a second object. In the embodiments discussed below, the fastener is specifically designed to secure an object in the form of a wear liner 19 to a structure 13, such as a transfer chute, whereby the fastener 11 allows the wear liner 19 to be quickly installed on and removed from the structure.

While the present invention provides a very quick and easy to use fastener to secure a wear liner 19 to a second surface 17 of the structure 13, it has particular application for those structures 13 having a first surface 15 which is either concealed, or which is problematic to access.

The wear liner 19 comprises a plurality of holes 25 which are arranged so that each hole 25 aligns with a corresponding slotted aperture 18 in the structure, to assist in securing the wear liner 19 to the structure, as is described below.

These apertures 18 may be formed in the structure or may be provided by other means, such as an adapter plate secured over a circular opening in the structure.

Upon alignment of each hole 25 with the respective slotted aperture 18, the fastener 11 may cooperate with each aligned hole 25 and aperture 18 to releasably retain the wear liner 19 with respect to the structure 13. As described below, each fastener 11 may then be fastened to secure the wear liner 19 to the structure 13.

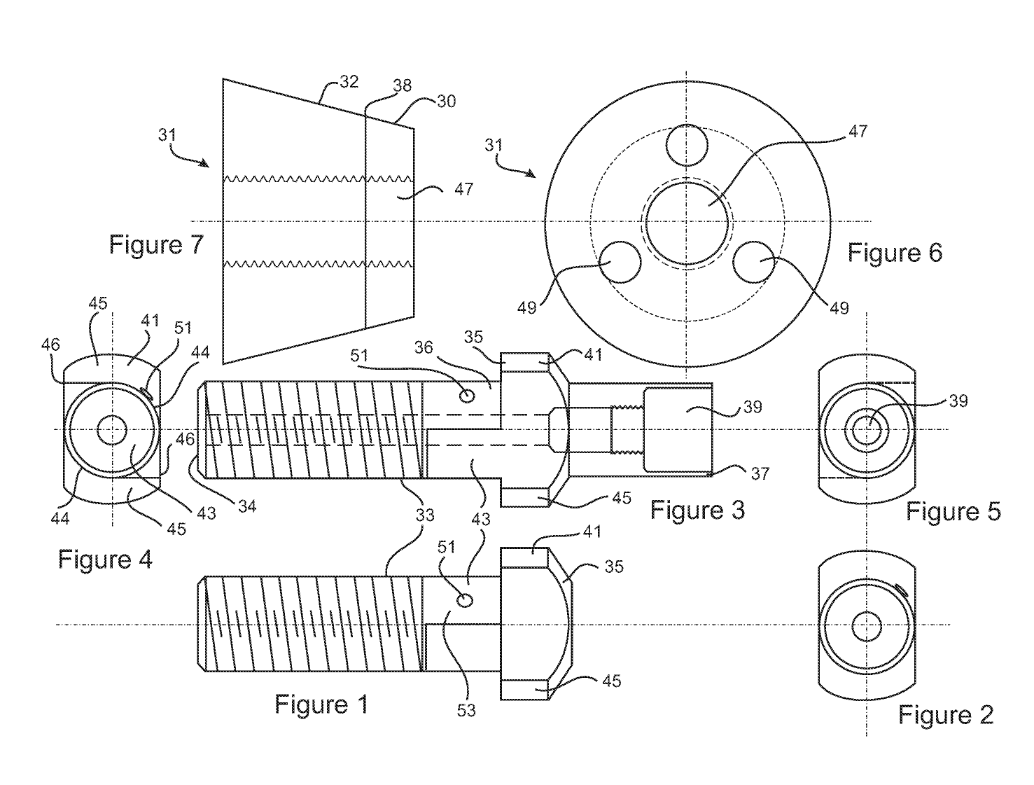

The wear liner 19 comprises a first surface 21, which engages the second surface 17 of the structure 13 when the wear liner is in place. The wear liner 19 also comprises a second surface 23 which is exposed to wear. Referring to FIGS. 1, 2, 4, 6 and 7 the invention according to the first embodiment is in the form of a fastener 11 comprising a head 31, a shank 33 which is threadingly received in the head 31, and a locking element 35. In this embodiment the locking element 35 is formed integrally with the shank 33 to provide a unitary member, as best shown in FIG. 1.

The locking element 35 is provided at a second end 36 of the shank 33. The locking element 35 comprises a clamping portion 41 and a locking member 43. The locking member 43 is adjacent the clamping portion 41 in a direction towards the first end 34 of the shank 33.

During fastening of the fastener 11, the locking element 35 moves from a first position relative to the aperture 18 in the structure 13, to a second position to releasably retain the wear liner 19 with respect to the structure 13. As described below each fastener 11 may then be fastened to secure the wear liner 19 to the structure 13, clamping the wear liner 19 and structure 13 between the head 31 and the clamping portion 41.

As best shown in FIG. 4, the cross sectional profile of the locking member 43 is of a square configuration modified such that two diagonally opposed corners 44 are curved, while diagonally opposed corners 46 remain unchanged for reasons which will be described below.

The clamping portion 41 comprises two arms 45 extending outwardly from the shank 33 in an opposed relation, as best shown in FIGS. 2 and 4.

The locking element 35 also provides a retaining means in the form of a detent arrangement. The detent arrangement in the present embodiment is provided by a resilient projection 51 extending from a surface 53 of the locking member 43.

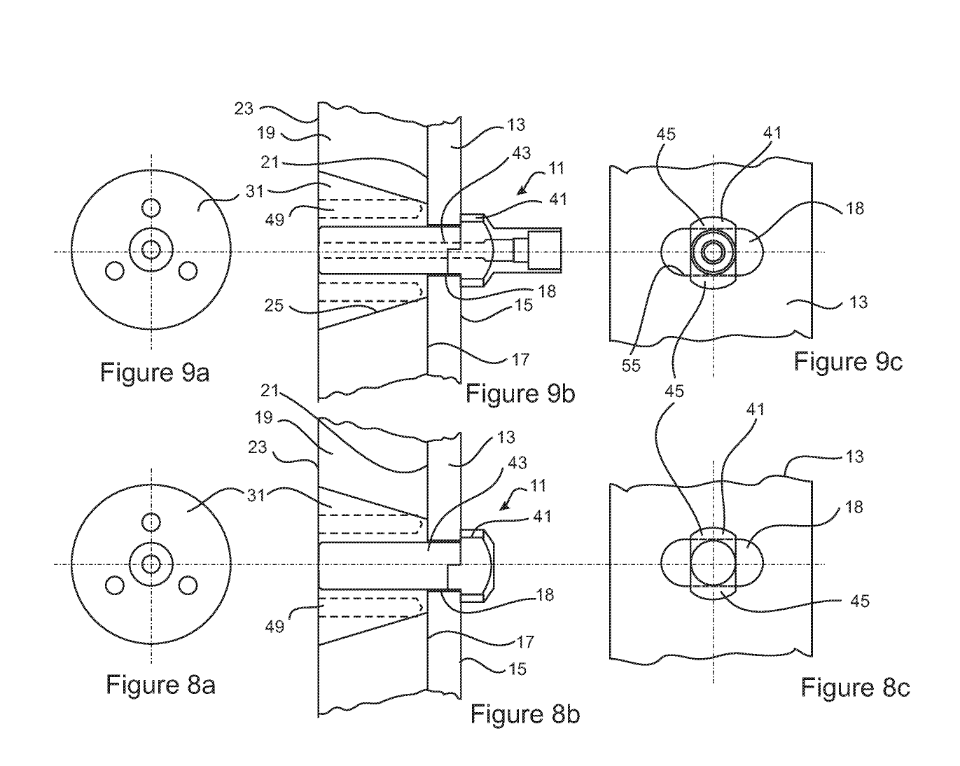

Referring to FIG. 7, the head 31 is adapted to threadingly receive an end of the shank 33 through a central opening 47. The head 31 also has three smaller openings 49 spaced equidistant around the central axis. These openings 49 extend through the tapered head 31 and terminate adjacent the bottom wall of the head 31, as can be seen in FIG. 8b, 9b.

The head 31 is frusto conical, having a first tapered sidewall 30 and a second tapered sidewall 32. At the junction of the first tapered sidewall 30 with the second tapered sidewall 32 the diameter of the first tapered sidewall 30 is larger than the second tapered sidewall 32 to provide an annular step 38. This difference in diameter enhances the clamping action and transfer of force from the head to the wear liner 19.

A second embodiment of the invention is shown in FIGS. 3 and 5. For convenience features that are similar or correspond to features of the fastener 11 of the first embodiment have been referenced with the same reference numerals. In the second embodiment the fastener 111 is adapted to receive a sensor (not shown). The fastener provides a housing 37 for the sensor. The housing extends from the locking element 35 and has an opening 39 for receiving the sensor. The opening 39 extends from the housing and terminates adjacent a first end 34 of the shank which is located remote from the locking element 35.

The application of the fastener 11, 111 is now discussed with reference to FIGS. 8 and 9. FIGS. 8 and 9 are schematic representations of the fastener 11, 111 fastened to secure the wear liner 19 to the structure 13, effectively clamping one relative to the other.

Generally to install the fastener 11 the fastener 11 is first assembled. During assembly a coating of a binding agent (not shown) is applied to the portion of the external thread of the shank 33 which is to be received in the head 31. The coating binds the head 31 to the shank 33 such that the head 31 resistively engages the shank 33, for reasons which will be described below.

Before installing the fastener 11, the wear liner 19 is positioned on the structure 13 such that the holes 25 in the wear liner 19 each align with a slotted aperture 18 incorporated in the structure. The locking element 35 of the fastener 11 is then inserted through the hole 25, and is orientated to be in a first position relative to the aperture 18 to allow the locking element 35 to pass into the aperture 18. As each hole 25 is larger in diameter than the extent of the arms 45 of the clamping portion 41, and as the extent of the arms 45 is less than the largest dimension of the slotted aperture 18 the clamping portion 41 can pass through the hole 25 and aperture 18 when the locking element 35 is in the first position relative to the aperture 18.

As best shown in FIGS. 8b, 9b, the fastener is inserted such that the clamping portion 41 passes through the slotted aperture 18 and a portion of the locking member 43 remains within the confines of the slotted aperture 18.

Once the fastener 11 is in position, a tool (not shown) engages the openings 49 in the head 31. Upon operation of the tool the head 31 is rotated clockwise. As the shank 33 is in resistive engagement with the head 31, the shank 33, which is integrally formed with the locking element 35, is caused to simultaneously rotate.

Upon rotation of the shank 33 and the locking element 35 the resilient projection 51 engages a side 55 of the aperture 18. Further rotation causes the resilient projection 51 to deform, permitting further rotation of the locking element 35 to the second position. The resilient projection 51 retains the locking element 35 in the second position, minimising the possibility of accidental rotation in the counter clockwise direction of the locking element 35 (i.e. accidental rotation from the second position to the first position).

Once the locking member 43 is in the second position, as shown in FIG. 8c, 9c, the locking member 43 is prevented from further rotation with further clockwise rotation of the head, due to the distance between the non-curved corners 46 of the locking member 43 being greater than the smallest dimension of the aperture 18.

Further rotation force may then be applied to the head 31 in a clockwise direction until the resistive engagement between the head 31 and the shank 33 is overcome. Once the resistive engagement is overcome the head 31 can rotate relative to the shank 31.

As the head 31 further rotates the distance between the head 31 and the clamping portion 41 is reduced until the wear liner 19 and structure 13 is clamped between the head 31 and the clamping portion 41, securing the wear liner 19 to the structure 13.

When the time comes to replace the wear liner 19, each fastener 11 needs to be loosened and removed, or positioned such that the locking element 35 is in the first position relative to the aperture 18. The fastener 11 may be loosened using the tool to rotate the head 31 in a counter clockwise direction.

In some instances the initial counter clockwise rotation of the head will cause the locking element 35 to move to the first position, allowing the fastener to be removed.

In other instances the head 31 will need to be rotated until the head 31 extends sufficiently above the surface of the wear liner 19 such that when the head is pushed back into the hole 25, the locking element 35 is no longer within the confines of the aperture 18 and may therefore be freely rotated until the locking element 35 is in the first position relative to the aperture 18. The fastener may then be removed.

As noted in FIGS. 8b and 9b the hole 25 in the wear liner 19 is conical/tapered. This complements the shape of the head 31 and enables the fastener to maintain engagement with the hole 25 such that the wear liner 19 remains secured to the structure 13, even as the head 31 and the wear liner 19 wear.

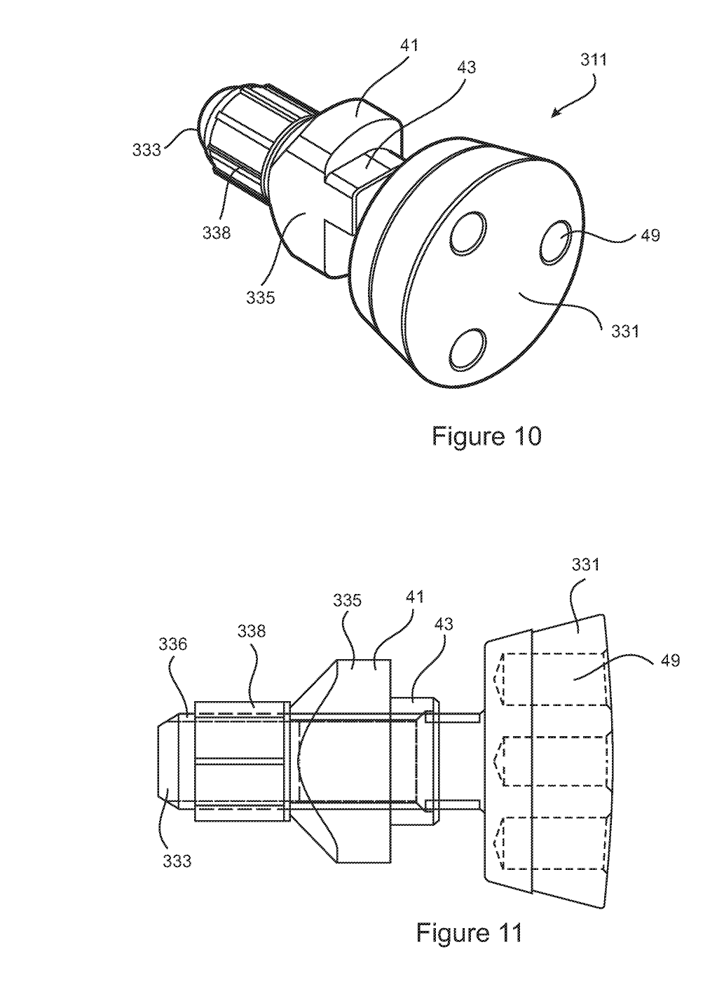

A third embodiment of the invention is shown in FIGS. 10, 11 and 12. For convenience, features that are similar or correspond to features of the fastener 11 of the first embodiment have been referenced with the same reference numerals.

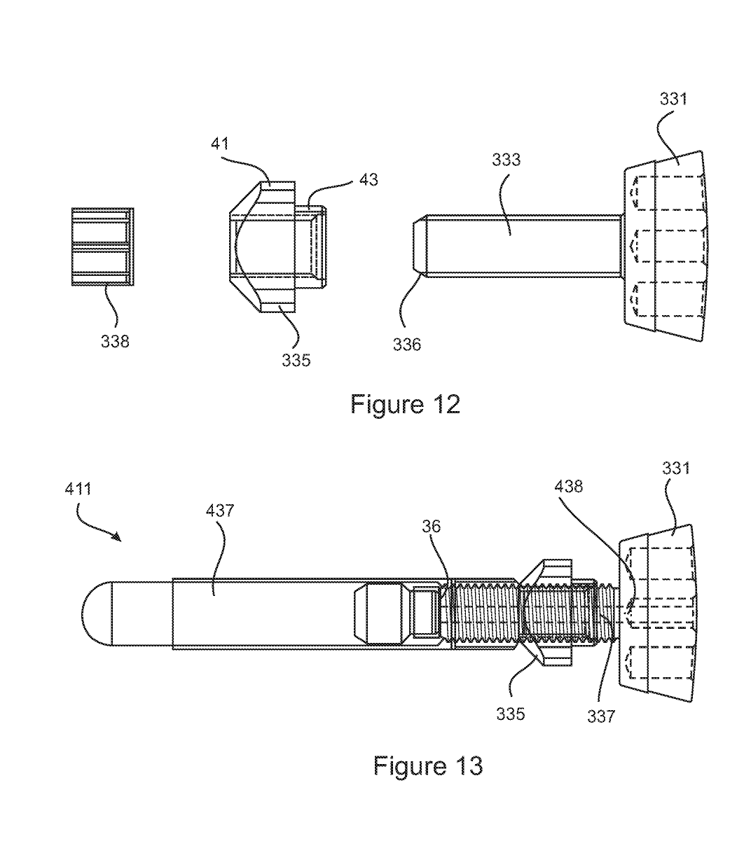

According to the third embodiment the fastener 311 comprises a head 331, a shank 333, and a locking element 335 which is adapted to be threadingly received on the shank 333. In this embodiment the head 331 is formed integrally with the shank 333 to provide a unitary member, as best shown in FIG. 12. With this arrangement the locking element 335 is adapted to travel along the shank 333 as the shank rotates. For example, during fastening of the fastener 311, the locking element 335 moves relative to the shank 333 in a direction towards the head 331.

Similar to the first embodiment, during fastening of the fastener 311, the locking element 335 moves from a first position in which the locking element 335 may pass through an aperture in the structure, to a second position, wherein the locking element 335 releasably fastens a wear liner with respect to the structure. The movement of the locking element 335 between first and second positions is facilitated by the rotation of the shank 333.

The locking element 335 is receivable in the aperture when the locking element 335 is in the first position. When the locking element 335 is in the second position the wear liner is releasably clamped to/retained relative to the structure.

The internal thread of the locking element 335 incorporates three regions of conelock crimping such that upon being threadingly received upon the shank 333 there is resistive engagement therebetween, for reasons which will be described below.

As with the first embodiment the locking element 335 incorporates a clamping portion 41 and a locking member 43. The locking member 43 is adjacent the clamping portion 41.

The fastener 311 further comprises a prevention means provided by a limiting means in the form of a collar 338. The collar 338 is adapted to be provided at a second end 336 of the shank 333. The collar 338 is positioned on the shank 333 so that when the fastener 311 is in position at least a portion of the locking member 43 is located within the aperture of the structure when the locking element 335 is either in its first position or its second position. This will prevent the locking element 335 from moving to the second position prematurely, which could potentially cause the fastening of the fastener to occur while the entire locking element 335 is external to the aperture.

The collar 338 also prevents the locking element 335 from becoming detached from the shank 333.

The installation and operation of the fastener 311 is similar to that of the previous embodiments. Once the fastener 311 is in position in the aperture, a tool (not shown) engages the openings 49 in the head 331. Upon operation of the tool the head 331 is rotated clockwise. As the shank 333 is in resistive engagement with the locking element 335, rotation of the head 331 and therefore rotation of the integral shank 333, will cause the locking element 335 to simultaneously rotate from the first position to the second position.

Once the locking element 335 is in the second position, the configuration of the locking member 43 prevents the locking element 335 from further rotation upon continued rotation of the head 331.

Further rotation of the head 331 in the same direction overcomes the resistive engagement between the shank 333 and the locking element 335. Once the resistive engagement is overcome the shank 333 can rotate relative to the locking element 335.

As the shank 333 is caused to further rotate the distance between the head 331 and the clamping portion 41 is reduced until the wear liner and structure is firmly clamped between the head 331 and the clamping portion 41, securing the wear liner to the structure.

When the time comes to replace the wear liner, each fastener 311 needs to be loosened such that the locking element 335 is rotated into the first position relative to the aperture. When in the first position the fasteners may be removed. The fastener 311 may be loosened using the tool to rotate the head 331 and integral shank 333 in a counter clockwise direction.

A fourth embodiment of the invention is shown in FIG. 13. For convenience, features that are similar or correspond to features of the fastener 311 of the third embodiment have been referenced with the same reference numerals.

In this embodiment, a fastener 411 has a shank which supports a sensor 437 located at the second end 36 of the shank 333. Where the sensor is in the form of a wear sensor, a sensor portion of the sensor may extend through the shank through bore 438 and into the head 331. As the head 331 wears, the sensor collects and sends data to an output wherein an operator can determine the state of wear the head 331 has experienced.

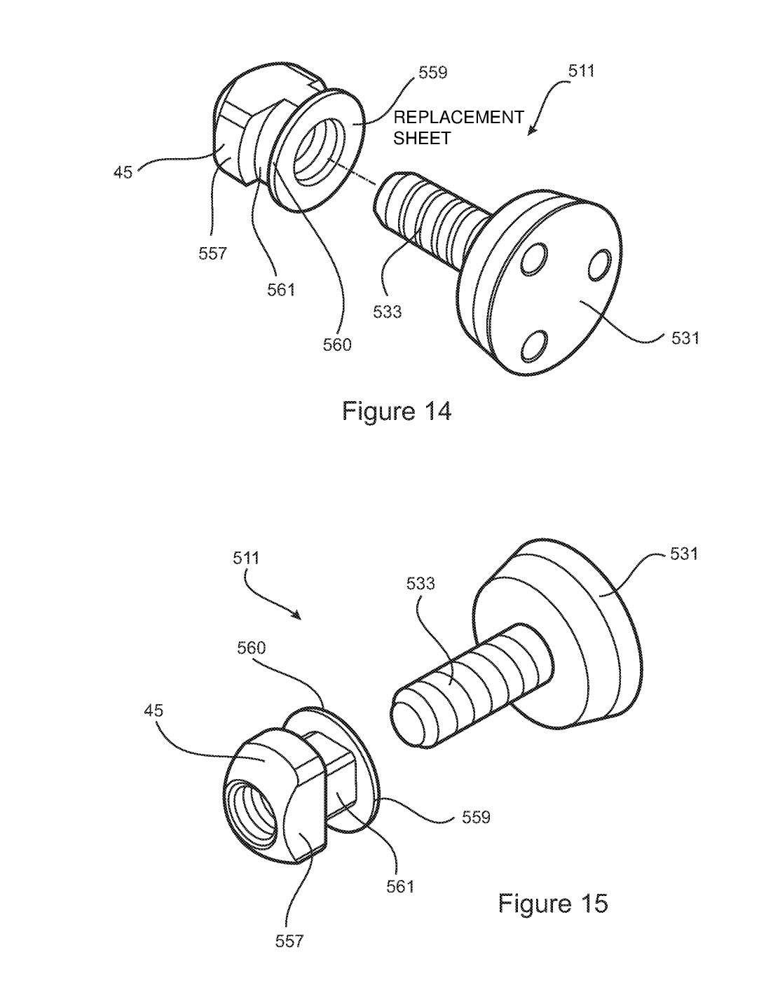

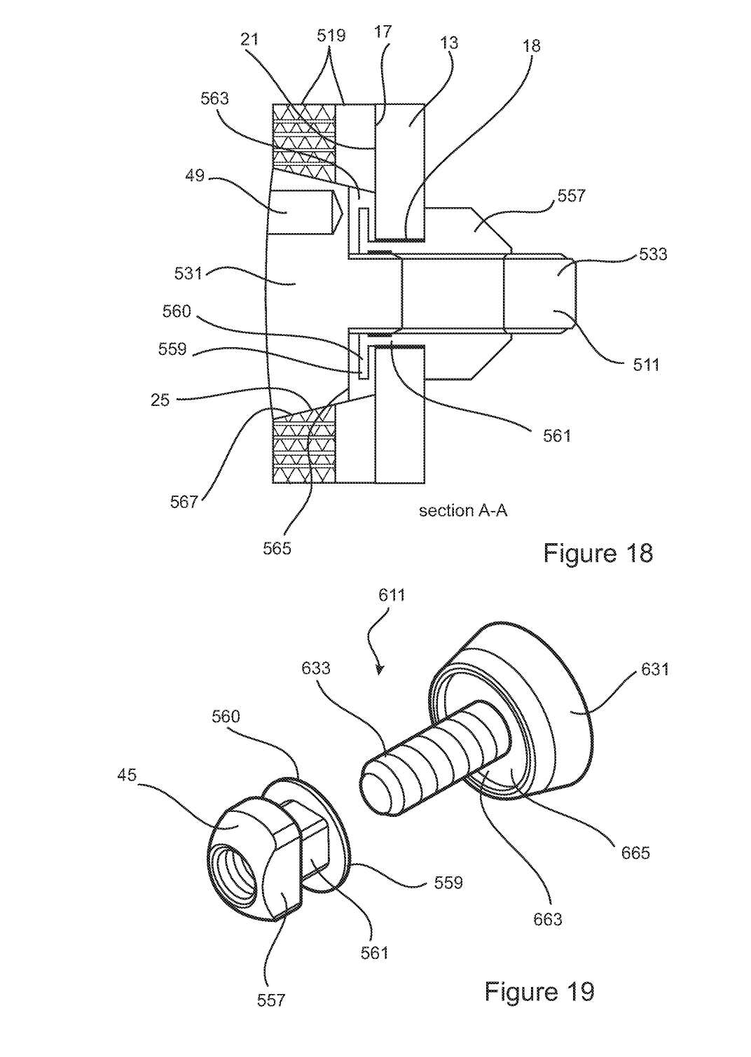

A fifth embodiment of the invention is shown in FIGS. 14 to 18. For convenience, features that are similar or correspond to features of the previous embodiments have been referenced with the same reference numerals.

The invention according to the fifth embodiment is in the form of a fastener 511 comprising a head 531, a nut 557 and a shank 533 which threadingly receives the nut 557. In this embodiment the head 531 is formed integrally with the shank 533 to provide a unitary member, as best shown in FIGS. 14 and 15.

The nut 557 comprises a locking element 535 and a prevention means provided by a limiting means in the form of a restriction element 559.

The restriction element 559 is provided by a flange 560 which is integral with the nut 557, as best shown in FIGS. 14 and 15. The flange 560 is constructed so that its smallest radial dimension is greater than the smallest radial dimension of the aperture 18 in the structure.

In this embodiment the flange 560 is spaced from the locking element 535 a distance equal to the length of a restraining portion 561 such that the distance between the locking element 535 and the flange 560 is fixed. This distance is slightly larger than the thickness of the aperture 18 in the structure 513,

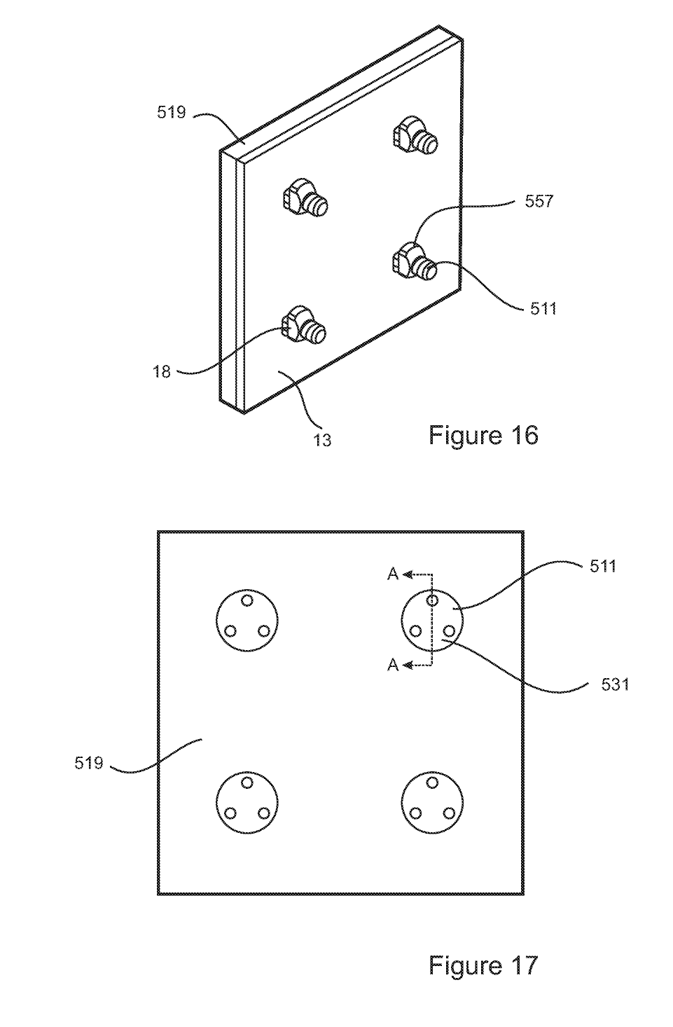

A wear liner 519 is illustrated in FIGS. 16 to 18. The wear liner 519 is shown secured to a structure 13 which, for simplicity, is shown as a plate. The wear liner 519 is releasably secured to the structure 13 using four releasable fasteners 511 according to the fifth embodiment.

Before installing each fastener 511, the wear liner 519 is positioned on the structure 13 such that the holes 25 in the wear liner 19 each align with a slotted aperture 18 incorporated in the structure. The locking element 535 of the fastener 511 is then inserted through the hole 25, and is orientated to be in a first position relative to the aperture 18 to allow the locking element 535 to pass into the aperture 18. As each hole 25 is larger in diameter than the extent of the arms 45 of the clamping portion 41, and as the extent of the arms 45 is less than the largest dimension of the slotted aperture 18 the clamping portion 41 can pass through the hole 25 and aperture 18 when the locking element 35 is in the first position relative to the aperture 18. However, as the smallest radial dimension of the flange 560 is greater than the smallest radial dimension of the aperture 18, the nut 557 cannot pass completely through the opening 18. This ensures that the restraining portion 561 of the nut 557 remains within the aperture 18, as best shown in FIG. 23.

In order to robustly secure the wear liner to the structure the interface of the first surface 21 of the wear liner and the second surface 17 of the structure must be free from irregularities. It is therefore necessary to accommodate the thickness of the flange 560. In so doing it is critical that the flange does not prematurely butt against the underside of the head 531 which would prevent the level of fastening required to secure the wear liner to the structure.

The present embodiment provides a bolt head 531 having a thickness less than the thickness of the wear liner hole 25 by an amount greater than the thickness of the flange 560. In operation, as the fastener 511 is fastened, the head 531 engages the sidewall 567 of the hole 25 before an underside 565 of the head 531 is flush with the first surface 21 of the wear liner 19. This defines a gap 563 which is thicker than the thickness of the flange 560, accommodating the flange 560 without compromising the fastening ability of the fastener 511.

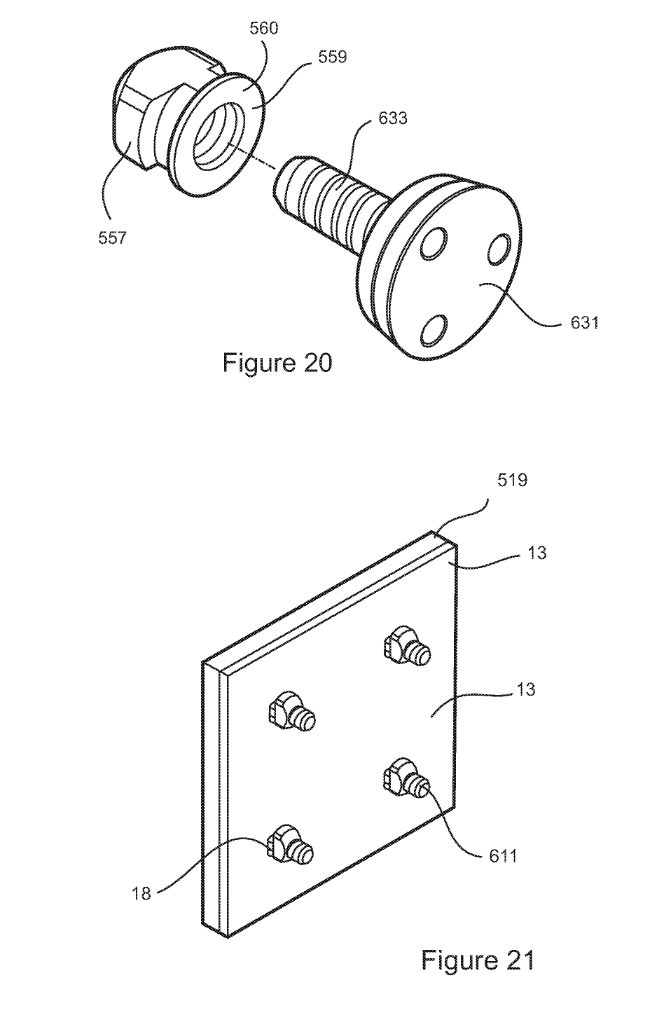

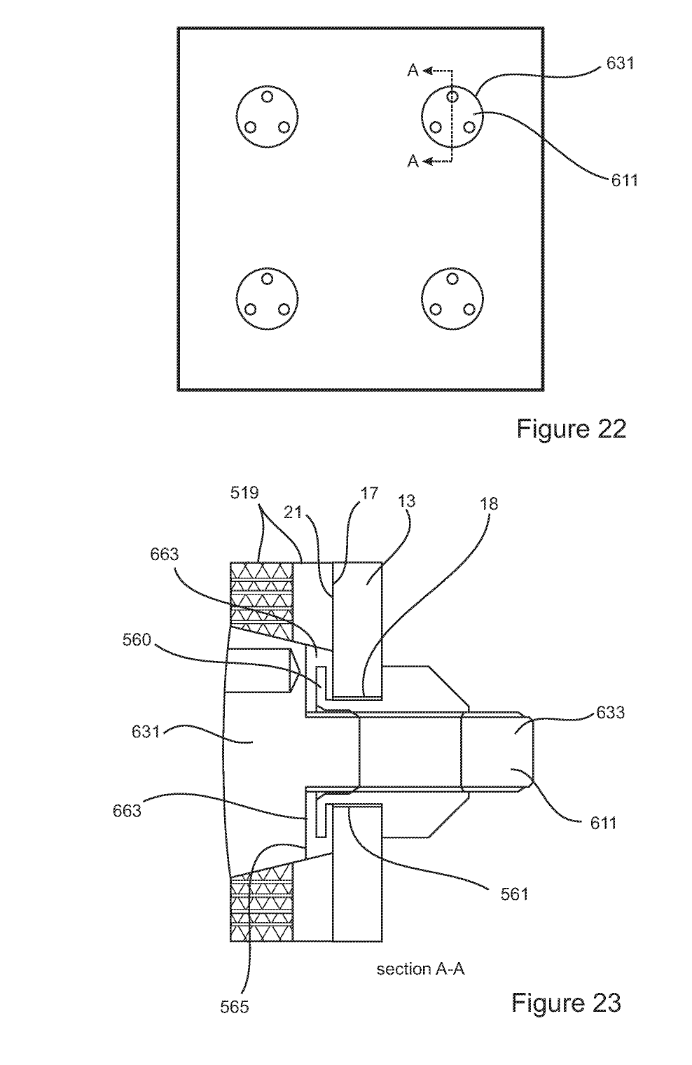

The invention according to a sixth embodiment, as shown in FIGS. 19 to 23, is in the form of a fastener 611 comprising a head 631, a nut 557 and a shank 633 which threadingly receives the nut 557. For convenience, features that are similar or correspond to features of the fastener 511 of the fifth embodiment have been referenced with the same reference numerals.

The fastener 611 of the sixth embodiment is similar to that of the fifth embodiment wherein the difference resides in the manner in which the thickness of the flange 560 of the nut 557 is accommodated. In this embodiment the fastener 611 provides a head 631 having a recess 663 formed in an underside 665, as shown in FIG. 19. This recess 663 is slightly deeper than the thickness of the flange 560. In operation, as the fastener 611 is fastened, the head 631 sits flush with the first surface 21 of the wear liner 19, with the flange 560 being received in the recess 663, as best shown in FIG. 23.

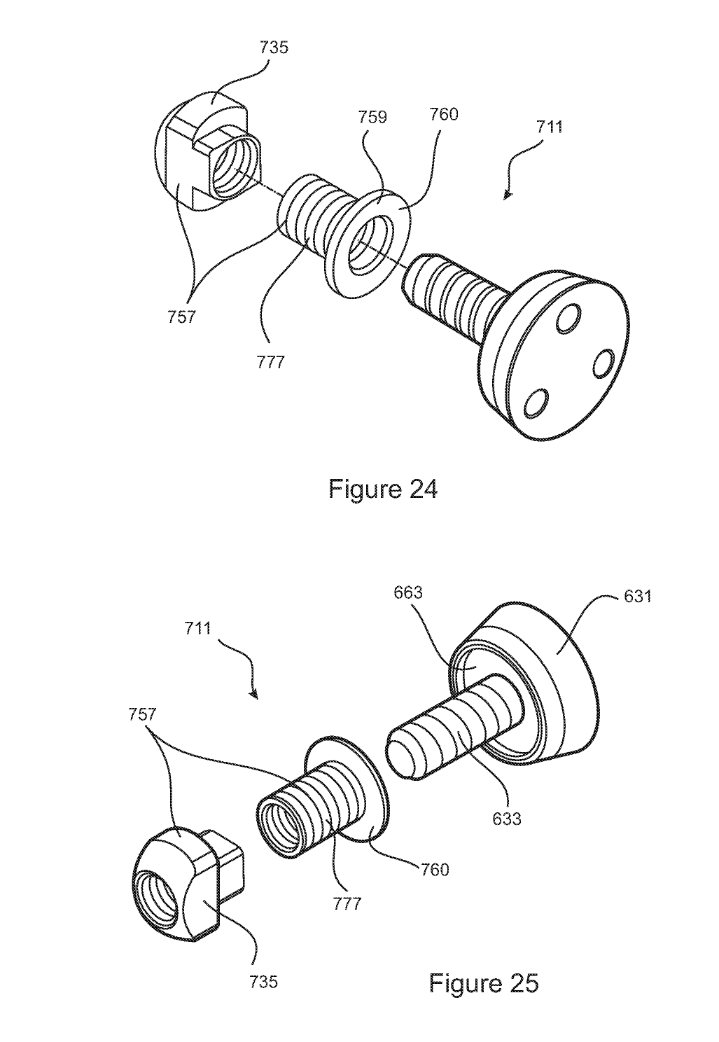

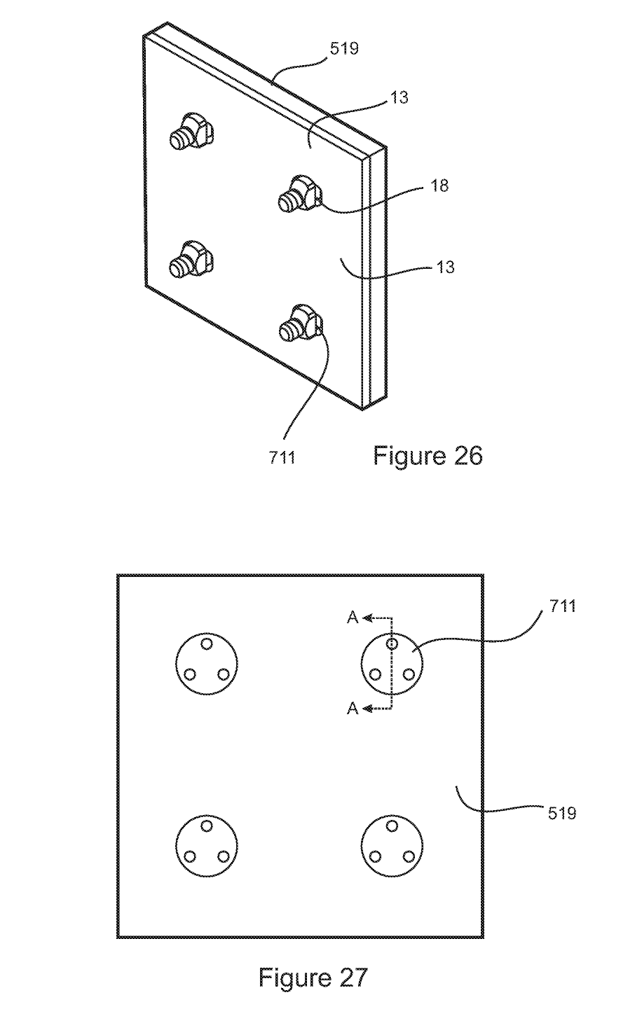

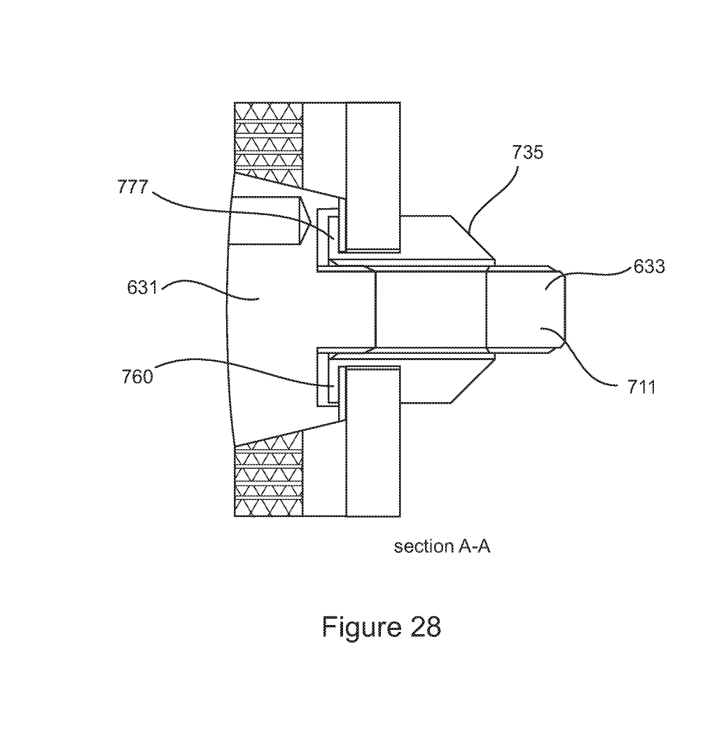

The invention according to a seventh embodiment, as shown in FIGS. 24 to 28, is in the form of a fastener 711 comprising a head 631, a nut 757 and a shank 633 which threadingly receives the nut 757. For convenience, features that are similar or correspond to features of the fastener 611 of the sixth embodiment have been referenced with the same reference numerals.

The fastener 711 of the seventh embodiment is similar to that of the sixth embodiment wherein the difference resides in the construction of the nut 757.

As best shown in FIGS. 24 and 25 the nut 757 is formed from two separate parts, a locking element 735 and a sleeve 777. The sleeve 777 provides a restriction element 759 and threadingly receives the locking element 735.

The restriction element 759 comprises a flange 760 and co-operates with the nut 757 such that the distance between the flange 760 and the locking element 735 is adjustable. The sleeve 777 is threadingly receivable on the shank.

One application in which the present invention has been particularly designed is for securing thick wear plates to a structure, for example a transfer chute in a conveyor system. Wear plates are generally very heavy and often need to be installed in relatively confined spaces. As such it is critical during the removal of wear liners for the fasteners to be in a position which ensures smooth extraction from the apertures in the structure. This becomes even more critical when the liner has multiple fasteners which secure the wear plate to the structure, as is generally the case. Embodiments of the present invention allow an operator to be relative sure that the fastener is loosened and the locking element of each fastener is in the first position wherein the clamping portion aligns with the aperture so that it may be removed from the slot.

Similar consideration is given when the wear plate installed. Owing to the nature of the fastener the operator can readily align and insert a fastener relative to the aperture knowing that upon fastening, the locking element will rotate to its second position, and that upon further rotating the clamping portion and head will clamp and fasten the wear plate relative to the structure.

Also in this application the head of the fastener can be configured to be flush with or lie below the wear liner's outer surface. This helps protect the head of the fastener as the side walls of the head are not exposed to abrasive material.

Modifications and variations such as would be apparent to the skilled addressee are considered to fall within the scope of the present invention. For instance the head and the shank may be a unitary member which is threadingly received in the locking element. The present invention is not to be limited in scope by any of the specific embodiments described herein. These embodiments are intended for the purpose of exemplification only. Functionally equivalent products, formulations and methods are clearly within the scope of the invention as described herein.

Reference to positional descriptions, such as lower and upper, are to be taken in context of the embodiments depicted in the figures, and are not to be taken as limiting the invention to the literal interpretation of the term but rather as would be understood by the skilled addressee.

Throughout this specification, unless the context requires otherwise, the word “comprise” or variations such as “comprises” or “comprising”, will be understood to imply the inclusion of a stated integer or group of integers but not the exclusion of any other integer or group of integers.

1. A releasable fastener for securing an object to a structure, the structure comprising a first surface, and a second surface against which the object is secured, a portion of the fastener being adapted to pass through the object and an aperture in the structure to engage a portion of the structure, the fastener comprising:
a head,
a shank integral with and extending from the head,
a locking element rotatably positioned on the shank, the locking element being adapted to operatively engage relative to the aperture such that during fastening of the fastener, the locking element rotates between a first position and a second position such that the object and structure are clampable between the head and the locking element.

2. The releasable fastener according to claim 1 comprising a prevention means to retain a restraining portion of the locking element within the aperture in the structure when fastening or unfastening the fastener.

3. The releasable fastener according to claim 2 wherein the restraining portion is configured to prevent rotation of the locking element beyond the second position, when fastening the fastener, and beyond the first position, when unfastening the fastener.

4. The releasable fastener according to claim 2 comprising a nut, the nut incorporating the locking element and the restraining portion.

5. The releasable fastener according to claim 4 wherein the prevention means is in the form of a restriction element which provides an obstruction to prevent the nut from passing entirely through the opening and retaining the restraining portion within the aperture of the structure.

6. The releasable fastener according to claim 5 wherein the restriction element is in the form of an enlarged portion wherein the smallest radial dimension of the enlarged portion is greater than the smallest radial dimension of the aperture of the structure.

7. The releasable fastener according to claim 5 wherein the restriction element is in the form of a flange integral with the nut and located at a distal end from the locking element, wherein the distance between the flange and the locking element is such that the restraining portion of the locking element remains within the aperture of the structure when the fastener assembly is received therein.

8. The releasable fastener according to claim 6 wherein the thickness of the restriction element is accommodated by one or a combination of a recess in an underside of the head of the fastener, a recess in a first surface of the object, a recess in the structure, or a recess in an intermediate layer located between the structure and the object.

9. The releasable fastener according to claim 6 wherein the thickness of the head is less than the depth of a hole in the object such that when received therein an underside of the head is inwardly spaced from the first surface of the object, whereby once fastened on the structure the thickness of the restriction element is accommodated in a gap formed between the underside of the head and the second surface of the structure.

10. The releasable fastener according to claim 6 wherein the nut provides the restriction element so that the restriction element is integral with the nut wherein the distance between the restriction element and the locking element is fixed.

11. The releasable fastener according to claim 6 wherein the restriction element co-operates with the nut such that the distance between the restriction element and the locking element can be varied.

12. The releasable fastener according to claim 4 wherein the prevention means is in the form of a limiting means located at or adjacent the end of the shank remote from the head.

13. The releasable fastener according to claim 12 wherein the limiting means is in the form of a collar secured to or adjacent the end portion of the shank.

14. The releasable fastener according to claim 13 wherein the limiting means is spaced from the locking element such that during at least installation of the releasable fastener the restraining portion of the nut remains within the aperture of the structure.

15. The releasable fastener according to claim 14 wherein the collar and nut combine to provide a limiting assembly wherein the collar and nut are in a predetermined spaced apart arrangement, such that when the limiting assembly is threadingly received on the shank and wound thereon, the distance between the collar and nut remain the same, and when the limiting assembly is wound off the shank the collar remains fixed while the nut moves toward the collar until it is in abutment therewith, preventing the nut from further rotation relative to the shank, wherein the space between the collar and nut is such that during at least installation of the fastener relative to the aperture, the restraining portion remains within the aperture.

16. The releasable fastener according to claim 1 wherein the aperture is slotted or it co-operates with an adapter which has a slotted aperture therein.

17. The releasable fastener according to claim 1 wherein the locking element is receivable in the aperture when the locking element is in a first position, and is releasably locked with respect to the structure when the locking element is in a second position.

18. The releasable fastener according to claim 1 wherein there is resistive engagement between the shank and the locking element, whereby the resistive engagement causes the locking element to rotate with the shank when the shank or head are rotated, the resistive engagement being overcome when the locking element has passed to a second position and sufficient force is applied thereto to overcome the resistive engagement.

19. The releasable fastener according to claim 1 wherein the locking element comprises:
a clamping portion wherein the clamping portion clamps the object to the structure when the fastener is fastened; and
a locking member to lock the clamping portion to prevent rotation of the clamping portion beyond the second position.

20. The releasable fastener according to claim 1 comprising a retaining means to retain the locking element in the second position and prevent, or at least minimise, accidental rotation of the locking element from the second position to the first position.

21. The releasable fastener according to claim 21 wherein the retaining means is in the form of a detent arrangement comprising a resilient projection extending from a surface of the locking member, whereby the projection engages the side of the aperture as the locking element passes between the first position to the second position.

22. The releasable fastener according to claim 1 comprising at least one sensor for measuring one or more of a variety of characteristics of the releasable fastener and/or the environment within which it operates.

23. A releasable fastener for securing an object to a structure, the structure comprising a first surface, and a second surface against which the object is secured, a portion of the fastener being adapted to pass through the object and a slotted aperture in the structure to engage a portion of the structure, the fastener comprising:
a head,
a shank integral with and extending from the head,
a nut comprising a locking element rotatably positioned on the shank, the locking element being adapted to operatively engage the slotted aperture such that during fastening of the fastener, the locking element rotates between a first position and a second position such that the object and structure are clampable between the head and the locking element.

24. A releasable fastener for securing an object to a structure, the structure comprising a first surface, and a second surface against which the object is secured, a portion of the fastener being adapted to pass through an opening in the object and an aperture in the structure to engage a portion of the structure, the fastener comprising:
a head,
a shank integral with and extending from the head,
a locking element rotatably positioned on the shank, the locking element being adapted to operatively engage relative to the aperture such that during fastening of the fastener, the locking element rotates between a first position and a second position wherein the object and structure are clampable between the head and the locking element;
a limiting means located at or adjacent an end portion of the shank remote from the head, the limiting means being sufficiently spaced from the locking element such that during at least removal of the releasable fastener a restraining portion of the locking element remains within the aperture.
